(19) United States
(12) Patent Application Publication
(10) Pub. No.: US 2009/0147701 A1
(43) Pub. Date: Jun. 11, 2009

(54) METHOD OF CONFIGURING A NETWORK INFRASTRUCTURE

(76) Inventors: Klaus REISTER, Dettingen/Teck (DE); Juergen Schmid, Zwiefalten (DE)

Correspondence Address: K.F. ROSS P.C., 5683 RIVERDALE AVENUE, SUITE 203 BOX 900, BRONX, NY, 10471-0900, US

(21) Appl. No.: 12/328,926

(22) Filed: Dec. 5, 2008

(30) Foreign Application Priority Data
Dec. 5, 2007 (DE) 102007058631.2

(51) Int. Cl. H04L 12/28

(52) U.S. Cl. 370/254

(57) ABSTRACT

A method of configuring a device forming part of a network infrastructure. The method has the steps of storing outside the network application- and user-specific configuration data for each device, and inputting to the device the respective configuration data. The data can be stored on, for example, a flash drive and transferred to the network device, e.g. a router, switch, or terminal, before or after it is actually put in place and connected into the network.

### FIELD OF THE INVENTION

The present invention relates to a network. More particularly this invention concerns a method of configuring a network.

### BACKGROUND OF THE INVENTION

Network infrastructures are known in principle. In addition to data lines that link individual network structures to each other, terminals (clients, such as personal computers and the like) are also arranged within the network infrastructure alongside these network infrastructure devices.

It is necessary for the network infrastructure devices (such as, e.g. switches and routers) to be configured so as to enable operation within the network infrastructure.

To do the configuration, the prior art provides that the network infrastructure device, such as, for example, the switch, be connected to a PC (for example, through a command line interface—CLI—or a web interface). Although an online configuration is in principle possible by this approach, this is true only after the entire network infrastructure or parts thereof have been set up and the devices of the network infrastructure have been put into operation. In the case of relatively large network infrastructures (such as, e.g. in production facilities or chemical-engineering plants) or in the case of widely separated network infrastructure devices, it can be extremely costly to implement an online configuration. Also disadvantageous is the fact that this type of online configuration is quite expensive in terms of time since the network infrastructure devices must be physically present first, after which the network is constructed, and then in turn after this the individual network infrastructure devices must be configured sequentially. That means that the network must be constructed first and then the individual network infrastructure devices configured, with the result that the startup of the entire network infrastructure is disadvantageously delayed.

### OBJECTS OF THE INVENTION

It is therefore an object of the present invention to provide an improved method of configuring a network infrastructure.

Another object is the provision of such an improved method of configuring a network infrastructure that overcomes the above-given disadvantages.

A further object is to provide such a method that allows a network to be set up and configured easily and quickly, without having to laboriously configure each device after it is made part of the network.

### SUMMARY OF THE INVENTION

A method of configuring a device forming part of a network infrastructure. The method has according to the invention the steps of storing outside the network application- and user-specific configuration data for each device, and inputting to the device the respective configuration data.

According to the invention, provision is made whereby application-specific data for each network infrastructure device, are stored, and only subsequently are loaded into the network infrastructure device. This way, the problem can be solved as follows: In network infrastructures, for example, for chemical-engineering plants, for automated facilities in fabrication and production, and the like, the network infrastructure (topology) is planned early on before implementation and startup of the network. It is known in this regard which devices (both network infrastructure devices as well as terminals) are to be installed at which locations, which address they are to be provided with (to operate them), and what other properties they are to have during subsequent operation within the network. Since this data in principle is already known, the configuration data required to operate the network infrastructure device within the entire network involve application-specific data that are provided in a configuration file and can be stored outside the network to be constructed and the network infrastructure devices to be set up ahead of time. As a result, it is possible according to the invention to provide the application-specific and user-specific data before the startup of the network, and to store this data in a configuration file without there having to be a data link to the network infrastructure device. As a result, it is possible to provide and store a configuration file for each network infrastructure device of the application-dependent network infrastructure for each network infrastructure device installed there. When the time now comes to construct the network infrastructure, the furnished network infrastructure devices are supplied with the respective configuration data that are application-specific and user-specific either before or after the network infrastructure device has been installed in the network infrastructure. As a result, what is involved here is an offline configuration of the network infrastructure devices, such as switches and routers, with the result that these can be put into operation immediately after their installation in the network infrastructure if the configuration data have been loaded into the network infrastructure device before the device is installed in the network infrastructure. However, even if the network infrastructure device must be provided with the supplied and stored configuration data after it has been installed in the network infrastructure, startup of the network proceeds significantly faster than would be possible for a configuration through CLI or a web interface.

In a further development of the invention, provision is made whereby the configuration data are temporarily stored in a storage medium, e.g. what is known as an autoconfiguration adapter that is preferably in the form of a USB flash drive, and, after the storage medium has been connected to the relevant network infrastructure device, this data is loaded into an appropriate storage medium of the network infrastructure device. This has the advantage that the network infrastructure devices do not have to be connected to the network for this procedure, with the result that configuration is possible without network connection.

What must be viewed as the fundamental advantage of the invention is the fact that the network infrastructure devices prepared for installation in the network infrastructure have already been provided ahead of time with the configuration data (offline), and that as a result they can be put into operation immediately after installation in the network infrastructure. As a result, the construction and startup of an application-specific and user-specific network can be completed significantly more simply, on a more individually customized basis, and faster.

We claim:

1. A method of configuring a device forming part of a network infrastructure, the method comprising the steps of:
storing outside the network application- and user-specific configuration data for each device; and
inputting to the device the respective configuration data.

2. The configuration method defined in claim 1 wherein the configuration data for each device is stored on a portable storage medium.

3. The configuration method defined in claim 2 wherein the data is inputted by being transferred from the portable storage medium to the respective device.

4. The configuration method defined in claim 4 wherein the data is transferred to the respective device before it is installed in the network infrastructure.

5. The configuration method defined in claim 4 wherein the data is transferred to the device after it is installed in the network infrastructure.

6. The configuration method defined in claim 1 wherein the device is a switch or router.
